(19) United States
(12) Patent Application Publication
(10) Pub. No.: US 2003/0184535 A1
(43) Pub. Date: Oct. 2, 2003

(54) Display panel drive circuitry

(75) Inventor: Yoshiyuki Okuda, Tsurugashima-shi (JP)

Correspondence Address: SUGHRUE MION, PLLC, 2100 PENNSYLVANIA AVENUE, N.W., WASHINGTON, DC, 20037, US

(73) Assignee: PIONEER CORPORATION

(21) Appl. No.: 10/395,124

(22) Filed: Mar. 25, 2003

(30) Foreign Application Priority Data
Mar. 29, 2002 (JP) 2002-93856
Jan. 9, 2003 (JP) 2003-3472
Feb. 19, 2003 (JP) 2003-40649

(51) Int. Cl. G09G 5/00

(52) U.S. Cl. 345/204

(57) ABSTRACT

Drive circuitry for a display panel which has peripheral circuits formed of an amorphous silicon material or organic semiconductor material. The drive circuitry includes a group of control lines for generating address signals on which address signal generation data made up of predetermined codes is superimposed, and a plurality of combinational logic circuits for capturing at least some of the control lines to decode the address signal generation data to generate an address signal. The drive circuitry connects the outputs of the combinational logic circuits to the respective address electrodes of the display panel. When supplying analog signals to data electrodes, similar combinational logic circuits are used to decode data electrode addresses.

### BACKGROUND OF THE INVENTION

1. Field of the Invention

The present invention relates to drive circuitry for use with a display panel comprising a plurality of address electrodes and a plurality of data electrodes that intersect one another with display elements disposed therebetween.

2. Description of the Related Art

Display panels comprising a plurality of address electrodes and a plurality of data electrodes that intersect one another with display elements disposed therebetween are known in the art. One of such display panels is an active matrix display panel that employs, as the display elements, organic electroluminescent (hereinafter simply referred to as “organic EL”) light-emitting elements. The configuration of such display panel is shown in FIG. 1 of the attached drawings.

Referring to FIG. 1, a display panel 10 includes a matrix array of display elements each comprising TFT (Thin Film Transistor) elements and an organic EL light-emitting element. For example, according to the VGA (Video Graphics Adaptor) standard, which is an international standard of display panels, the display panel 10 includes 640 (multiplied by R, G, and B) columns times 480 rows of display elements or dots. The display panel 10 is connected to a peripheral circuit (i.e., an X transfer circuit) 20 that supplies display data signals to each of the 640 (multiplied by R, G, and B) columns of display elements. That is, the X transfer circuit 20 has 640 data electrodes extending in parallel for each R, G, and B of the display elements. The data electrodes extend in the X-axis direction of the display panel 10.

The display panel 10 is also connected to a Y transfer circuit 30 (another peripheral circuit). The Y transfer circuit 30 selects each of the 480 rows of display elements at predetermined time intervals and supplies a selection signal or an address signal to the display elements of a selected row. From the Y transfer circuit 30, 480 address electrodes extend in the Y-axis direction of the display panel 10. The peripheral circuits of the display panel 10 (i.e., the X transfer circuit 20 and the Y transfer circuit 30) are herein referred to as the drive circuitry for the display panel 10.

FIG. 2 of the accompanying drawings illustrates the inner configuration of the display panel 10 and the drive circuitry shown in FIG. 1. The configuration of only the Y transfer circuit 30 is shown in FIG. 2 because the configurations of the X transfer circuit 20 and the Y transfer circuit 30 are generally identical to each other.

As illustrated in FIG. 2, display elements 11 are arrayed in a matrix on a surface of the display panel 10. Major components of the display element 11 are a light-emitting element EL, a data write transistor Q1, a light-emitting element drive transistor Q2, and a storage capacitor C. The light-emitting operation of the display elements 11 can be described as follows. That is, a Y transfer pulse (address signal) is superimposed on an address electrode 13 at predetermined address time intervals to turn on the transistor Q1. At this time, electric charge caused by an X transfer pulse (data signal) superimposed on a data electrode 12 is stored in the capacitor C via the transistor Q1. Once the electric charge is stored in the capacitor C, the charge causes a high potential at the gate of the transistor Q2 to turn on the transistor Q2, thereby allowing a drive current to flow from a voltage supply Vcc to the light-emitting element EL and causing the light-emitting element EL to emit light.

The Y transfer circuit 30 comprises a plurality of shift registers 32, clock supply lines 31 for supplying clock signals or Y transfer clocks to the shift registers 32, and the address electrodes 13.

The shift register 32 is a so-called one-bit latch circuit, in which the logic level at an input terminal IN (hereinafter referred to as an “input”) appears at an output terminal OUT (hereinafter referred to as an “output”) in sync with a Y transfer clock applied to a clock input terminal CLK. In FIG. 2, there are provided shift registers in 480 stages in cascade connection corresponding to the respective rows of the display panel 10. The outputs of the shift registers 32 are connected with their respective address electrodes 13 for supplying an address signal to each row of display elements in the 0th to 479th rows.

The operation of the Y transfer circuit 30 shown in FIG. 2 is described below with reference to the time chart of FIG. 3 of the attached drawings.

First, suppose that a Y transfer pulse (a triggering Y transfer pulse) resulting in an address signal for selecting each row of display elements in the display panel 10 is applied to the input of the shift register 32 located at the first stage. The Y transfer pulse has a duration in time less than or equal to one period of the Y transfer clock.

The shift register 32 is a latch circuit that operates in sync with a clock signal applied thereto. Therefore, at the rise of the first Y transfer clock after a Y transfer pulse has been applied, the Y transfer pulse appears at the output of the shift register 32 located at the first stage. Likewise, in sync with the Y transfer clock or a shift clock, the Y transfer pulse is transmitted sequentially to the shift registers 32 at the lower stages one by one. As described above, the triggering Y transfer pulse has a pulse width (duration) not greater than one period of the Y transfer clock. Therefore, the Y transfer pulse that appears at the output of each of the shift registers 32 connected in cascade always has a duration in time equal to the duration of one Y transfer clock (about 34.7 microseconds (μs)).

As shown in FIGS. 2 and 3, since the outputs of the shift registers 32 at all stages are connected with their respective address electrodes 13, Y transfer pulses are supplied sequentially, at one-clock intervals of the Y transfer pulses, to each row of display elements of the display panel 10. The Y transfer pulse supplied to each address electrode 13 of the display panel 10 serves as an address signal for selecting the display elements in each row.

In the display panel 10 as shown in FIG. 1, it is necessary to scan all the rows of display elements in a screen during one frame period of an image to be displayed (e.g., 1/60 Hz=16.666 . . . ms). Therefore, if the display panel 10, the X transfer circuit 20 and the Y transfer circuit 30 are configured as shown in FIG. 2, one period of the Y transfer clock is about 34.7 microseconds (μs) (about 28.8 kHz) because 16.7 ms/480 rows is approximately equal to 34.7 microseconds (μs) (about 28.8 kHz).

The X transfer circuit 20 of FIG. 2 has generally the same configuration as that of the Y transfer circuit 30, performing the same operation. The X transfer circuit 20 scans each of the columns within one row-addressing period of the Y transfer circuit 30, that is, within one clock period of the Y transfer clock (about 34.7 μs). Accordingly, the shift registers in the X transfer circuit 20 operate very fast; the X transfer clock is higher thousands times or more in frequency than the Y transfer clock.

Conventionally, the so-called low temperature polysilicon material has typically been employed as the semiconductor materials to form the peripheral circuits of the display panel 10. However, recent active matrix display panels have commonly employed amorphous silicon materials or organic semiconductor materials that are less expensive and facilitate manufacture of the peripheral circuits, in place of the low temperature polysilicon material.

Unlike the low temperature polysilicon material, however, the amorphous silicon material can only be used to fabricate N-channel transistors, and the organic semiconductor material can only be used to fabricate P-channel transistors. Accordingly, the shift register that requires complementary transistor pairs using both the P-channel and N-channel transistors cannot be implemented with only one of the aforementioned two types of semiconductor materials. That is, it has been very difficult to employ only either amorphous silicon transistors or organic transistors to fabricate the peripheral circuits for driving the display elements of the active matrix display panel.

### SUMMARY OF THE INVENTION

One object of the present invention is to provide drive circuitry for use with a display panel having peripheral circuits formed of amorphous silicon transistors or organic transistors.

According to one aspect of the present invention, there is provided a drive circuitry for a display panel having a plurality of address electrodes and a plurality of data electrodes, intersecting one another with display elements being disposed therebetween, said drive circuitry comprising: a plurality of address signal generation control lines; an address signal generation data supply circuit for supplying coded address signal generation data to said plurality of address signal generation control lines such that each digit of said coded address signal generation data corresponds to each of said plurality of address signal generation control lines; and a plurality of combinational logic circuits for capturing at least some of said address signal generation control lines to generate an address signal in accordance with states of bits on said captured control lines, wherein an output of each of said combinational logic circuits is connected to each of said address electrodes.

### BRIEF DESCRIPTION OF THE DRAWINGS

FIG. 1 is a block diagram showing the configuration of an active matrix display panel;

FIG. 2 is a block diagram showing the configuration of the display panel and drive circuitry shown in FIG. 1;

FIG. 3 is a time chart representing an operation of the drive circuitry (the Y transfer drive circuit) shown in FIG. 2;

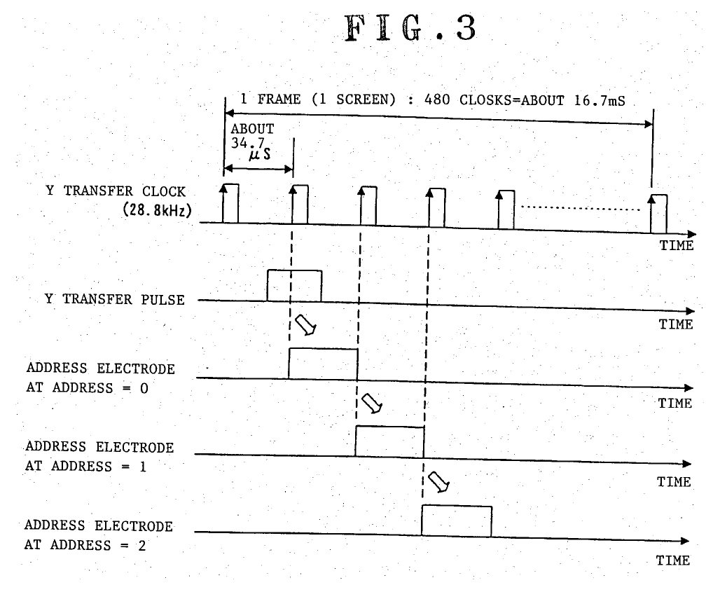

FIG. 4 illustrates a block diagram of a drive circuitry according to a first embodiment of the present invention;

FIG. 5 illustrates an example of binary codes superimposed on a group of data control lines that generate address signals in the circuitry of FIG. 4;

FIG. 6 illustrates the state of bits extracted from the group of data control lines by a combinational logic circuit in the circuitry of FIG. 4;

FIG. 7 is a circuit diagram showing the combinational logic circuit in the circuitry of FIG. 4 when the logic circuit is implemented by an AND circuit employing N-channel transistors;

FIG. 8 is a circuit diagram showing the combinational logic circuit in the circuitry of FIG. 4 when the logic circuit is implemented by an OR circuit employing P-channel transistors;

FIG. 9 is a circuit diagram showing the combinational logic circuit in the circuitry of FIG. 4 when the logic circuit is implemented by a NOR circuit employing N-channel transistors;

FIG. 10 is a circuit diagram showing the combinational logic circuit in the circuitry of FIG. 4 when the logic circuit is implemented by a NAND circuit employing P-channel transistors;

FIG. 11 is a circuit diagram showing the combinational logic circuit in the circuitry of FIG. 4 when the logic circuit is implemented by a combination of an AND circuit and a NOR circuit which employ N-channel transistors;

FIG. 12 depicts a circuit diagram of the combinational logic circuit in the circuitry of FIG. 4 when the logic circuit is implemented by a combination of an OR circuit and a NAND circuit which employ P-channel transistors;

FIG. 13 depicts a circuit diagram of the combinational logic circuit in the circuitry of FIG. 4 when the logic circuit is implemented by an AND circuit employing organic diodes;

FIG. 14 is a circuit diagram showing the combinational logic circuit in the circuitry shown in FIG. 4 when the logic circuit is implemented by an OR circuit employing organic diodes;

FIG. 15 illustrates an example of gray codes superimposed on the group of data control lines according to a second embodiment of the present invention;

FIG. 16 illustrates the state of bits extracted from the group of data control lines by a combinational logic circuit in the second embodiment;

FIG. 17 illustrate a block diagram of a drive circuitry according to a third embodiment of the present invention when the teaching of the present invention is applied to the X transfer circuit connected to the display panel;

FIG. 18 illustrates a block diagram of a drive circuitry according to a fourth embodiment of the present invention in which the sample and hold circuits shown in FIG. 17 are replaced by sampling switch circuits;

FIG. 19 is a time chart representing an operation of the drive circuitry (the X transfer drive circuit) shown in FIG. 18;

FIG. 20 is a circuit diagram showing a specific circuit configuration according to the embodiment shown in FIG. 18;

FIG. 21 shows an example employing binary codes for a group of codes to be superimposed on a group of X control lines;

FIG. 22 is a circuit diagram according to a fifth embodiment of the present invention, showing a modification to the circuit configuration shown in FIG. 18;

FIG. 23 is a circuit diagram according to a sixth embodiment of the present invention, showing the configuration of when reset input circuits are added to the circuitry shown in FIG. 20;

FIG. 24 is a circuit diagram according to a seventh embodiment of the present invention, showing the configuration of when reset input circuits are added to the circuitry shown in FIG. 22; and

FIG. 25 illustrates an example employing gray codes for a group of codes to be superimposed on a group of X control lines.

### DETAILED DESCRIPTION OF THE INVENTION

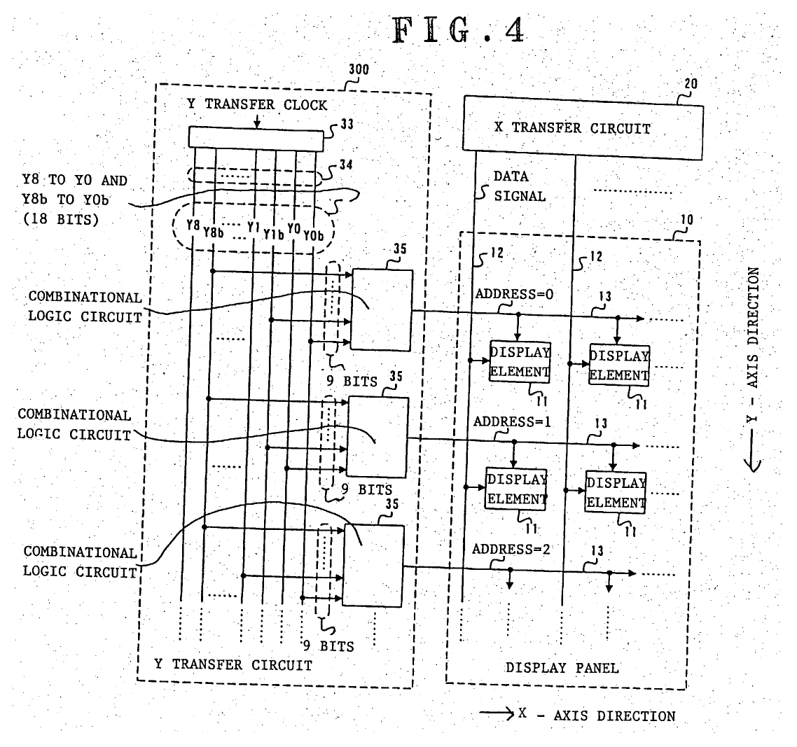

Now, display panel drive circuitry according to an embodiment of the present invention is described with reference to FIG. 4 and other drawings. The block diagram of FIG. 4 shows an embodiment in which the present invention is applied to the Y transfer circuit in the drive circuitry of an active matrix display panel.

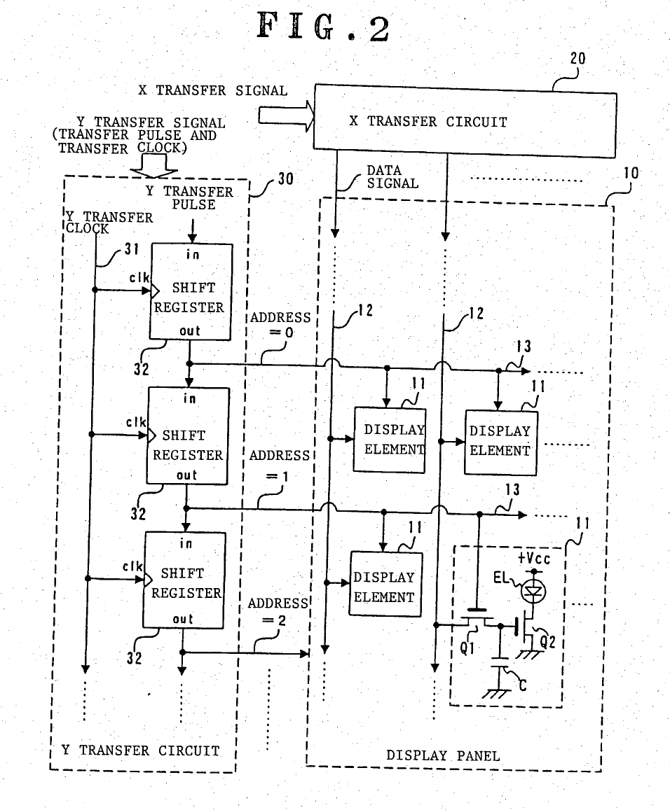

In FIG. 4, it should be understood that various settings such as the number of data electrodes, the number of address electrodes and the frequencies of different types of clocks are the same as those of the circuits described above in connection with FIG. 2. In addition, the components (e.g., display elements 11) same as those shown in FIG. 2 are denoted with the same reference symbols or numerals and will not repeatedly described below to avoid the redundancy of the description.

Referring to FIG. 4, a Y transfer circuit 300 has a similar function to the Y transfer circuit 30 of FIG. 2. Specifically, the Y transfer circuit 300 can generate an address signal for selecting each row of display elements of the display panel 10 in sync with the Y transfer clock. In this embodiment, the Y transfer circuit 300 comprises a group of data control lines for generating address signals (hereinafter referred to as a “group of control lines”) 34 on which data for generating address signals is superimposed, an address signal generation data supply circuit 33 for supplying data for generating address signals to the group of control lines 34, combinational logic circuits 35, and address electrodes 13.

The data for generating address signals is a group of original codes for generating the address signals. In this embodiment, such a group of codes includes 2⁰ to 2^{N} digit pulse signals, which is obtained by counting the Y transfer clocks described in connection with FIG. 2 by a N-scale binary counter, and pulse signals obtained by inverting these digit pulse signals.

In this particular embodiment, the display panel 10 has 480 rows of display elements arranged in the Y-axis direction. Therefore, the number of bits for a binary code which is required to generate the address of each of the 0th to 479th rows can be determined by the following relation:

512>480>256,

or

2⁹>480>2⁸.

Specifically, a 9-bit binary code is sufficient to prepare the addresses of each row.

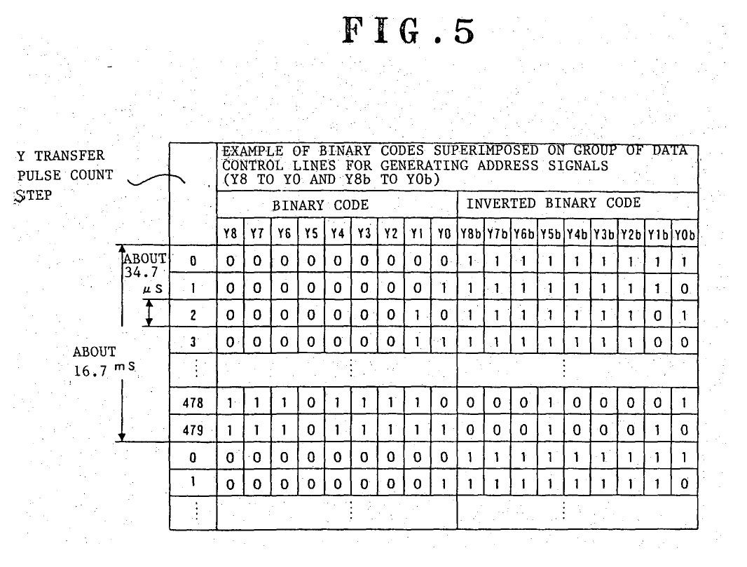

Therefore, the address signal generation data supply circuit 33 can be configured with a 480-scale binary counter for counting the Y transfer clock and an inverter circuit (not shown). As shown in FIG. 5, the address signal generation data generated by the circuit 33 takes the form of 9-bit binary codes and their inverted codes, and these 18-bit binary codes are superimposed on the group of control lines 34. That is, the group of control lines 34 is made up of 18 control lines with a binary code of 9 bits Y8(MSB) to Y0(LSB) and a binary code of their inverted bits Y8b(MSB) to Y0b(LSB) being superimposed on each line.

In order to count the Y transfer clocks (at about 28.8 kHz), the scale-of-480 binary counter has a count step of about 34.7 μs, which is one period of the Y transfer clock, as shown in FIG. 5. The time required for the scale-of-480 binary counter to reach 480 counts is about 16.7 ms (about 34.7 μs times 480 steps) corresponding to one frame period of a display screen. “480 counts” is one cycle of counting by the scale-of-480 binary counter.

The combinational logic circuit 35 is a so-called combinational logic circuit, which includes in combination logic gate circuits such as NAND gates and NOR gates. The combinational logic circuit 35 is required for each of the rows (horizontal lines) of the display panel 10. Thus, this embodiment employs 480 combinational logic circuits 35 each corresponding to one of the 0th to 479th address electrodes. As shown in FIG. 4, each of the combinational logic circuits 35 is connected with control lines of 9 bits extracted from the group of control lines 34. Each of the combinational logic circuits 35 performs a predetermined logical operation on a 9-bit signal transmitted via the 9-bit control line, and produces an output signal corresponding to (selected based on) a unique input condition. This output signal is a selection signal for the associated address electrode.

The group of control lines 34 in this embodiment is 18 control lines on which a binary code of 9 bits Y8(MSB) to Y0(LSB) and a binary code of their inverted bits Y8b(MSB) to Y0b(LSB) are superimposed. When decoding the 0th to 479th rows of address electrodes, therefore, 9 bits of the 18-bit codes superimposed on these control lines take always on “1,” with the remaining 9 bits inevitably taking on “0.” In this embodiment, those 9 control lines which take on “1” when the address electrode of the combinational logic circuit 35 in question is decoded are selected from the group of control lines 34, and the selected 9 control lines are connected as inputs to the combinational logic circuit 35.

Since the input signals to the combinational logic circuit 35 are determined as described above, the combinational logic circuit 35 can perform (complete) a logical operation on the input signals by only ANDing all the input signals, on the assumption that the logic level of the input signal is positive. This significantly reduces the complexity of the combinational logic circuit 35 and makes it possible to employ the same circuit configuration for implementing all the combinational logic circuits 35 of the 0th to 479th rows of address electrodes.

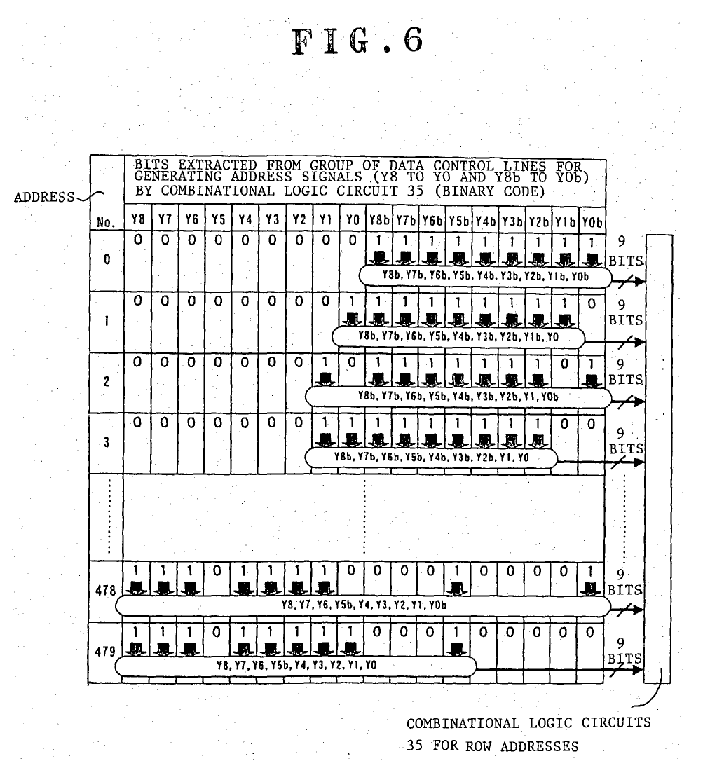

Referring to FIG. 6, described is the operation for extracting 9-bit control lines from the group of control lines 34 to decode certain address electrodes and then supplying the extracted 9-bit control lines (or their bits) to the associated combinational logic circuits 35.

In FIG. 6, let's consider a situation where a binary code and its inverted code for decoding the 2nd row of address electrodes of the display panel 10 are superimposed on each control line of the group of control lines 34. In this case, the bits of the binary code and its inverted code superimposed on the group of control lines 34 are as follows:

| Y8 | Y7 | Y6 | Y5 | Y4 | Y3 | Y2 | Y1 | Y0 | Y8b | Y7b | Y6b | Y5b | Y4b | Y3b | Y2b | Y1b | Y0b |
|---|---|---|---|---|---|---|---|---|---|---|---|---|---|---|---|---|---|
| 0 | 0 | 0 | 0 | 0 | 0 | 0 | 1 | 0 | 1 | 1 | 1 | 1 | 1 | 1 | 1 | 0 | 1 |

Therefore, as shown in the oval area at the column indicated by address No. 2 in FIG. 6, extraction of 9 bits [Y8b, Y7b, Y6b, Y5b, Y4b, Y3b, Y2b, Y1, and Y0b] makes it possible to provide the state in which all bits have a logic level of “1.” That is, the combinational logic circuit 35 for decoding the 2nd row of address electrodes of the display panel 10 can be connected at its inputs with those control lines corresponding to the 9 bits [Y8b, Y7b, Y6b, Y5b, Y4b, Y3b, Y2b, Y1, and Y0b].

Likewise, for example, as shown in the column indicated by address No. 478 in FIG. 6, the combinational logic circuit 35 for decoding the 478th row of address electrodes of the display panel 10 can be connected at its inputs with those control lines corresponding to 9 bits [Y8, Y7, Y6, Y5b, Y4, Y3, Y2, Y1, and Y0].

The circuit configuration of the combinational logic circuit 35 is described below. As described above, in this embodiment, it is possible to employ the same circuit configuration for all the combinational logic circuits 35 included in the Y transfer circuit 300. Assuming the positive logic, such a combinational logic circuit can be formed as an AND circuit for ANDing all 9-bit inputs.

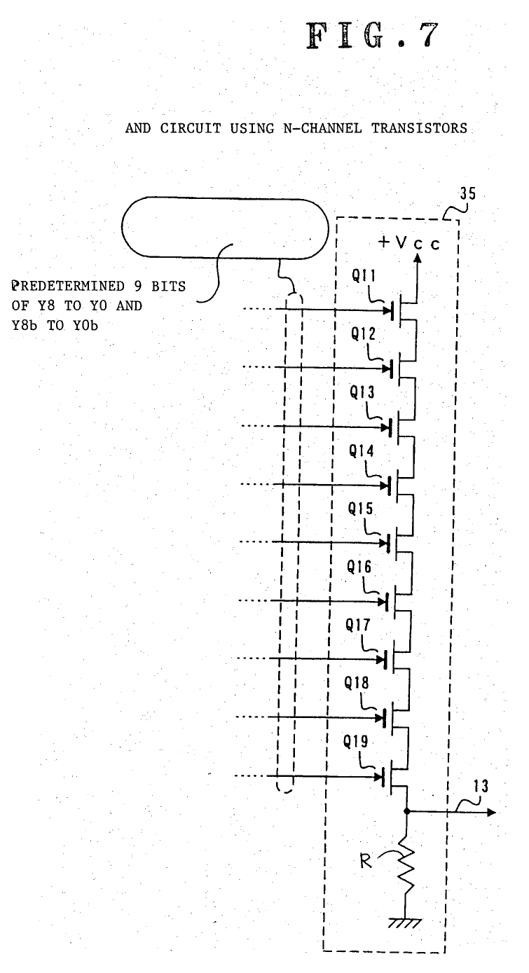

FIG. 7 shows such a combinational logic circuit 35 formed of N-channel transistors. In FIG. 7, symbols Q11 to Q19 designate N-channel MOS transistors and can be readily formed, for example, of an amorphous silicon material. As can be seen from FIG. 7, all the drain and source terminals of each of the N-channel MOS transistors Q11 to Q19 are connected in series between the voltage supply +Vcc and a resistor R. Therefore, only when inputs to all the gate terminals of the N-channel MOS transistors Q11 to Q19 are at a “high level” or logic level of “1,” the level of the voltage supply +Vcc or the logic level of “1” appears at the address electrode 13 or the output of the combinational logic circuit 35. With inputs to the gate terminals of the N-channel MOS transistors Q11 to Q19 having the combinations other than that, the combinational logic circuit 35 produces an output at the ground potential level or logic level of “0” via the resistor R.

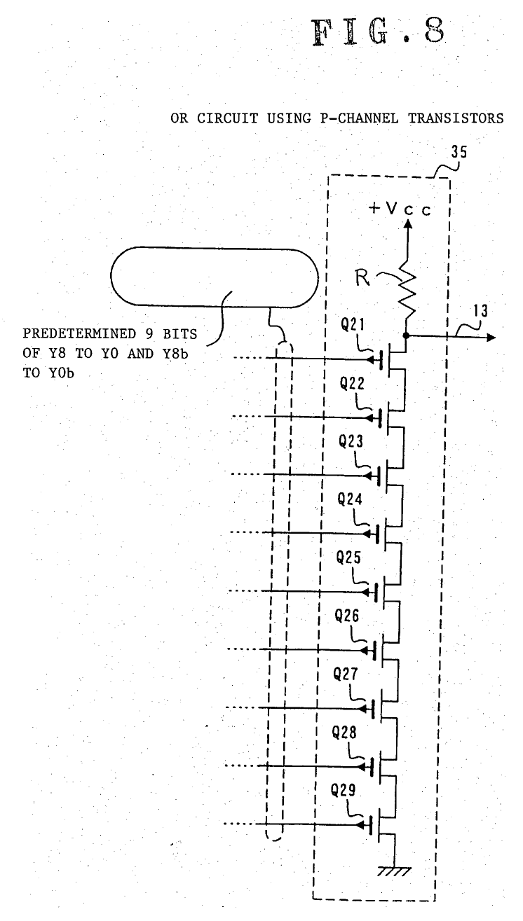

The configuration of the combinational logic circuit 35 in this embodiment is not limited to that of the circuit shown in FIG. 7. For example, according to the De Morgan's theorem, it is known that the logical product according to the positive logic is equal to the logical sum according to the negative logic. Therefore, as shown in FIG. 8, setting the negative logic to the circuit operation in this embodiment makes it possible to form the combinational logic circuit 35 using P-channel transistors.

Referring to FIG. 8, reference symbols Q21 to Q29 designate P-channel MOS transistors and can be readily formed, for example, of organic transistors made of an organic semiconductor material. All the drain and source terminals of each of the P-channel MOS transistors Q21 to Q29 are connected in series between the voltage supply +Vcc and the ground via a resistor R. Therefore, only when inputs to all the gate terminals of the P-channel MOS transistors Q21 to Q29 are at a “low level” or logic level of “0,” the address electrode 13 or the output of the combinational logic circuit 35 is at the ground potential level or logic level of “0.” With inputs to the gate terminals of the P-channel MOS transistors Q21 to Q29 having the combinations other than that, the combinational logic circuit 35 produces an output at the level of the voltage supply +Vcc via the resistor R or the logic level of “1”.

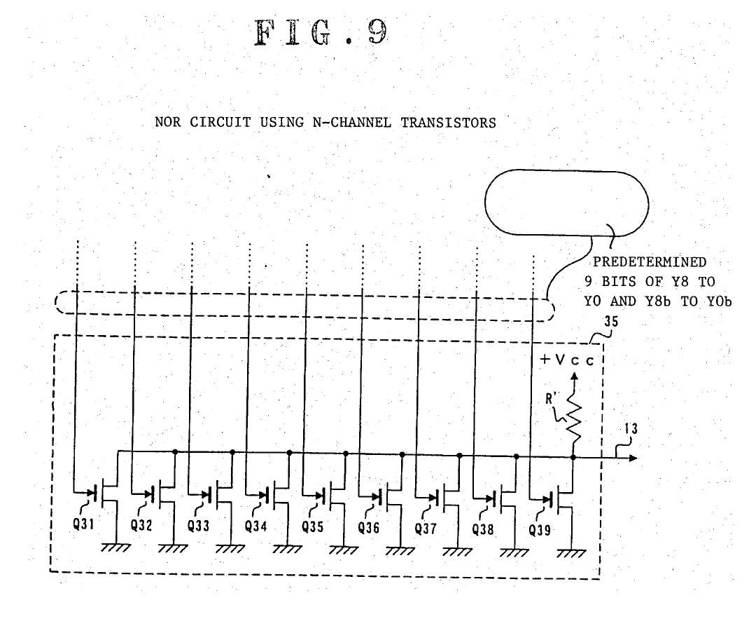

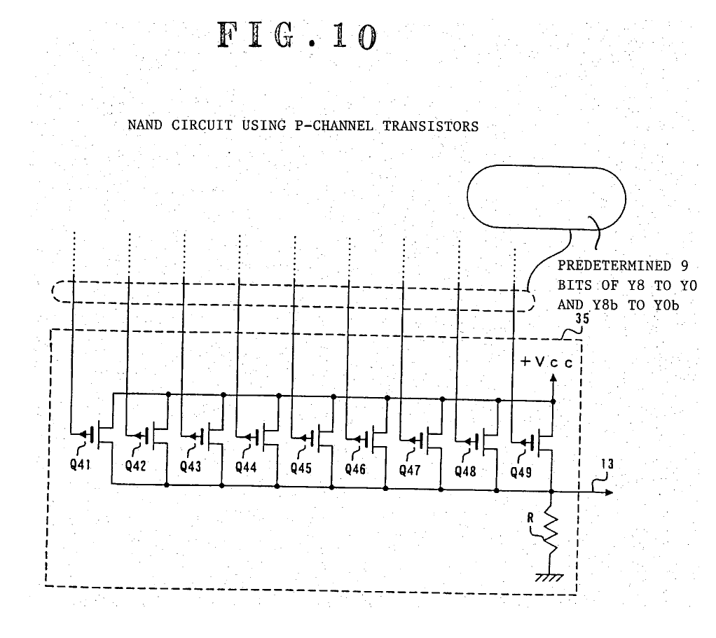

As described above, the combinational logic circuit 35 is formed by the N-channel or P-channel transistors connected in series. However, the combinational logic circuit 35 can also be formed such that the transistors are connected in parallel so as to provide a NOR or NAND logic circuit (FIGS. 9 and 10).

FIG. 9 shows a NOR combinational logic circuit 35 comprising N-channel MOS transistors Q31 to Q39 connected in parallel. When all the gate terminals of the MOS transistors Q31 to Q39 are at a low level, the address electrode 13 or the output of the combinational logic circuit 35 is at a high level. FIG. 10 shows a NAND combinational logic circuit 35 comprising P-channel MOS transistors Q41 to Q49 connected in parallel. When all the gate terminals of the MOS transistors Q41 to Q49 are at a high level, the address electrode 13 or the output of the combinational logic circuit 35 is at a low level.

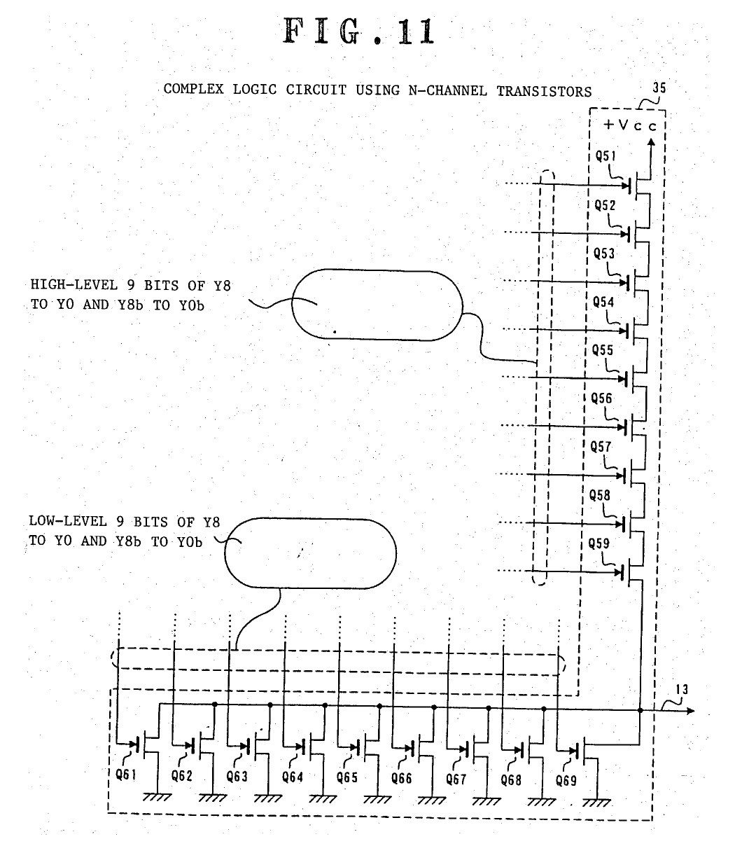

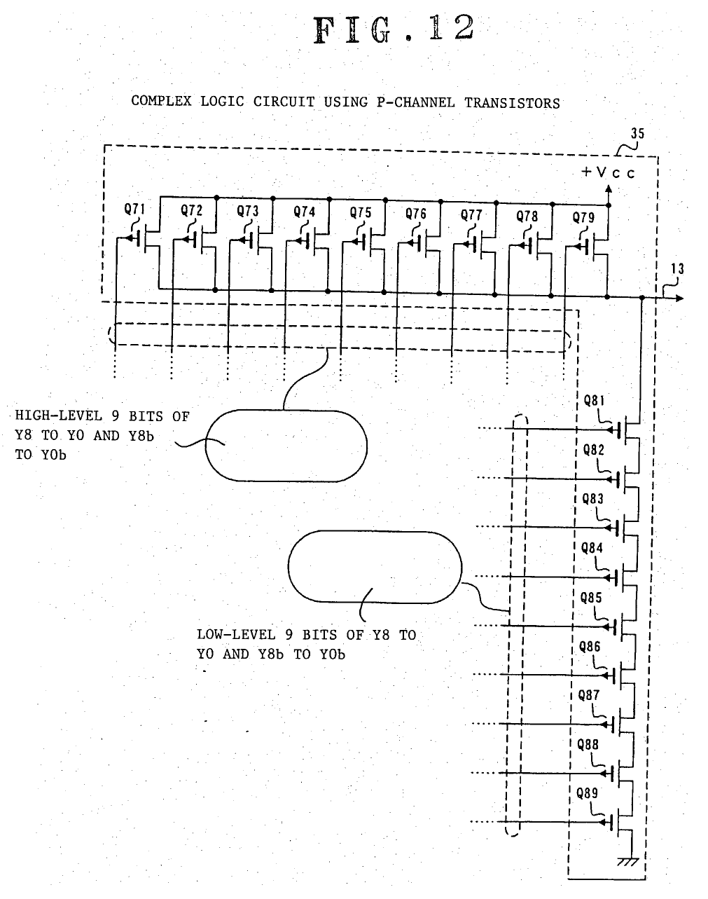

Alternatively, the combinational logic circuit 35 may be formed by a combination of the serial and parallel logic circuits, using the N-channel transistors or the P-channel transistors (FIGS. 11 and 12).

FIG. 11 shows a combinational logic circuit 35 formed in a combination of an AND circuit having N-channel MOS transistors Q51 to Q59 connected in series and a NOR circuit having N-channel MOS transistors Q61 to Q69 connected in parallel. In the circuit 35, its output or the associated address electrode 13 is at a high level when all the gate terminals of the transistors Q51 to Q59 are at a high level and all the gate terminals of the transistors Q61 to Q69 are at a low level. FIG. 12 shows a combinational logic circuit 35 including an NAND circuit having P-channel MOS transistors Q71 to Q79 connected in parallel and an OR circuit having P-channel MOS transistors Q81 to Q89 connected in series. In the circuit 35, its output or the address electrode 13 is at a low level when all the gate terminals of the transistors Q71 to Q79 are at a high level and all the gate terminals of the transistors Q81 to Q89 are at a low level.

The logic circuit 35 having the combined configuration shown in FIG. 11 or FIG. 12 allows all the control lines included in the group of control lines 34 to be collectively drawn into the logic circuit 35 irrespective of the difference in decode address. Therefore, a single wiring design or layout can be used for the interfaces between all the combinational logic circuits 35 for decoding the address electrodes and the group of control lines 34 on the same layout.

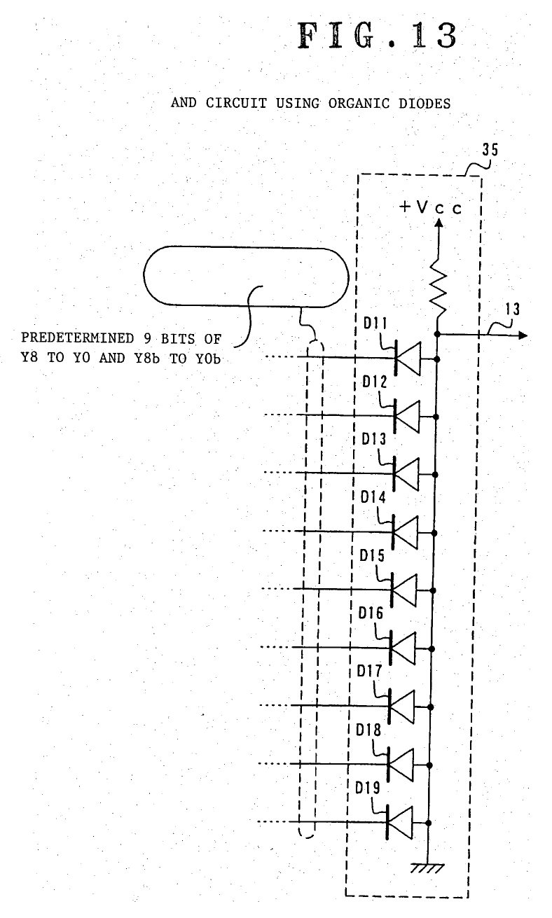

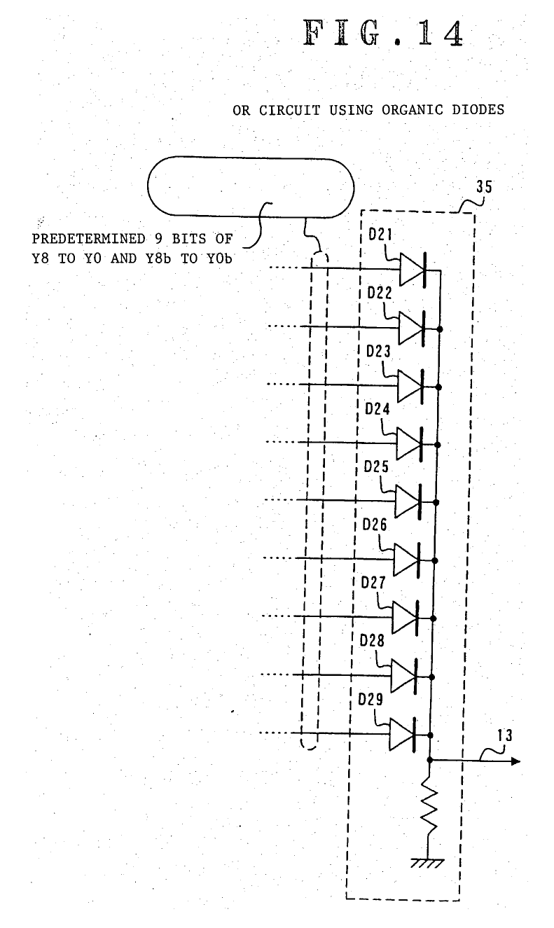

Further, the combinational logic circuit 35 can be formed of a logic circuit employing diodes (FIG. 13 or 14). For example, organic diodes made of an organic semiconductor material can be used to form an AND circuit based on the positive logic (FIG. 13) or an OR circuit based on the negative logic (FIG. 14). In the circuit based on the positive logic shown in FIG. 13, when all inputs to the cathodes of diodes D11 to D19 are at the logic level of “1,” the address electrode 13 or the output of the circuit 35 is at the logic level of “1.” In the circuit based on the negative logic in shown FIG. 14, when all inputs to the anodes of diodes D21 to D29 are at the logic level of “0,” the address electrode 13 or the output of the circuit 35 is at the logic level of “0.”

As described above, the combinational logic circuit 35 can be formed only of single-polarity transistors (P-channel or N-channel transistors) or diodes. Thus, the display panel drive circuitry can be formed using an amorphous silicon material or organic semiconductor material, without using a polysilicon material.

Now, another drive circuitry for the display panel (second embodiment of the present invention) will be described below.

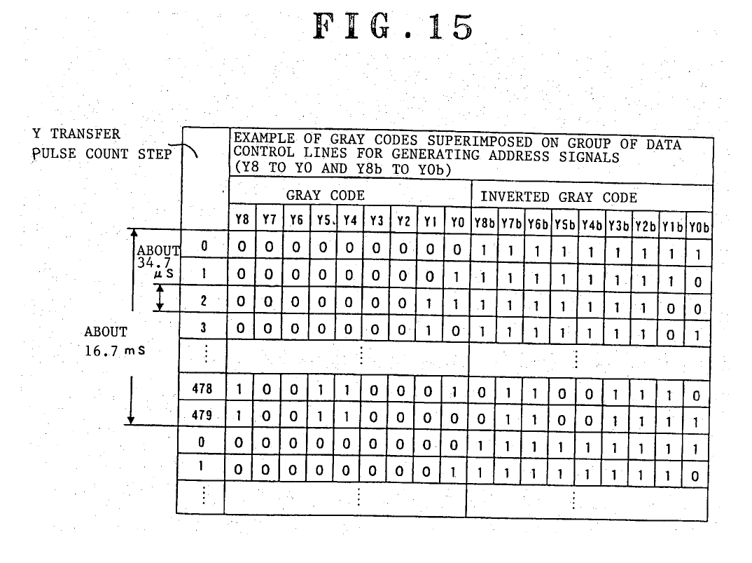

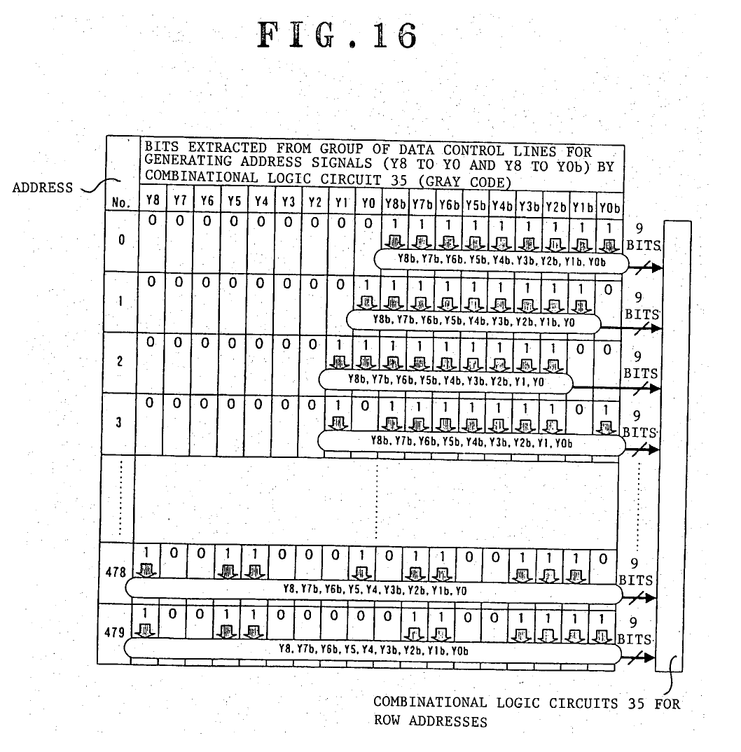

The second embodiment is characterized in that gray codes are used instead of binary codes as a group of codes for address signal generation data. In this embodiment, as shown in FIG. 15, the codes supplied from the address signal generation data supply circuit 33 to the group of control lines 34 for generating address signals are thus made up of a gray code and its inverted code. The bits to be extracted from the group of control lines 34 and then introduced to the combinational logic circuit 35 are shown in FIG. 16.

As can be seen from FIG. 15, adjacent gray codes have only one different bit. It is thus possible to reduce drawbacks such as a hazard occurring upon switching of input code data to the combinational logic circuit 35 or unevenness of switching waveforms.

This embodiment is different from the first embodiment only in the code format of the codes to be used as address signal generation data. In the other features, the configuration of a display panel drive circuitry in the second embodiment is the same as that of the first embodiment. Thus, the configuration and operation of this embodiment is not described again.

Now, a third embodiment will be described below in which the present invention is applied to the X transfer circuit of the display panel drive circuitry.

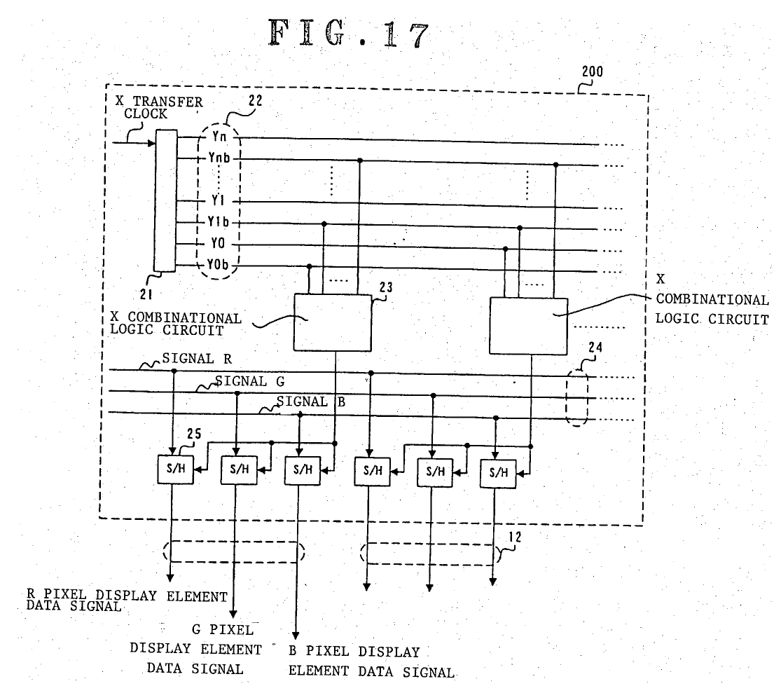

An X transfer circuit according to this embodiment is shown in FIG. 17. In this drawing, an X transfer circuit 200 is the X transfer drive circuitry for a display panel. The X transfer circuit 200 comprises an X address signal generation data supply circuit (hereinafter referred to as the “X supply circuit”) 21, a group of data control lines for generating X address signals (hereinafter referred to as a “group of X control lines”) 22, X combinational logic circuits 23, a group of analog signal input lines 24, and sample and hold circuits 25. The X address signal generation data corresponds to the address signal generation data in the Y transfer circuit 300 (FIG. 4).

It is necessary to superimpose three (RGB) types of data signals included in the group of analog signal input lines 24 on X transfer data electrodes 12 for each column of display elements on the display panel. Thus, the sample and hold circuits 25, which latch their outputs in accordance with output signals from the respective X combinational logic circuits 23, are used to hold each of R, G, and B analog signals temporarily and then supply each signal to the respective data electrodes 12.

As described above with reference to the display panel device shown in FIG. 2, the active matrix display panel is designed to store the potential of a data signal in the storage capacitor C of the display element 11 on the display panel, and then adjust the light-emitting drive current for the organic EL light-emitting element contained in the display element 11 in accordance with the potential. Therefore, the smaller the capacity of the storage capacitor C, the shorter the time required to write the data potential to the capacitor. This eliminates the need to hold the potential of the analog signal during a line scan period using the sample and hold circuit 25. In other words, with a reduced capacity of the storage capacitor C, the sample and hold circuits 25 shown in FIG. 17 may be made up of simple analog switches for supplying each of R, G, and B analog signals to the respective data electrodes 12 or prohibiting (intercepting) passage of the R, G, and B analog signals to the data electrodes 12. For example, it is also possible to use diode-based logic circuits to integrate such sampling analog switches with the X combinational logic circuits 23.

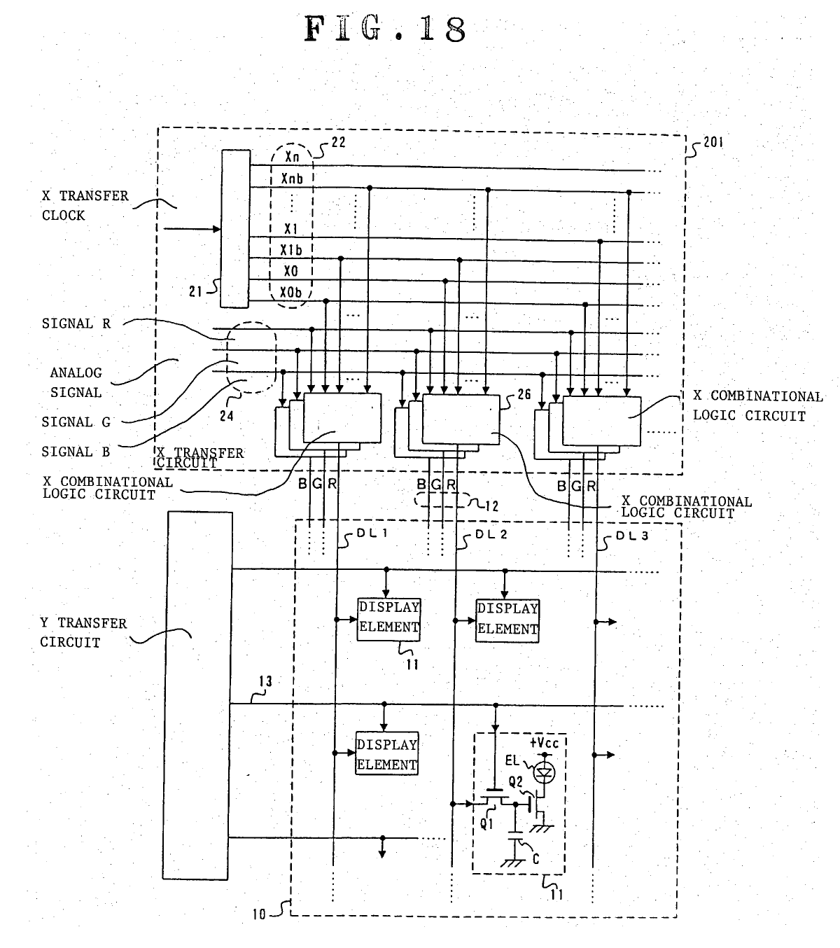

FIG. 18 shows an X transfer drive circuitry for a display panel configured as described above (fourth embodiment). Thus, FIG. 18 illustrates a modification to the third embodiment shown in FIG. 17. In the fourth embodiment, the present invention is also applied to the X transfer circuit of the display panel drive circuitry. The fourth embodiment makes it possible to eliminate the sample and hold circuits 25 thereby obviating the need of operational amplifiers that are otherwise inevitable for forming the circuits. Thus, the fourth embodiment provides a simplified configuration for the X transfer drive circuit. This also provides such a merit of avoiding adverse effects caused by variations in offset characteristics of the operational amplifiers between adjacent display elements on the display panel.

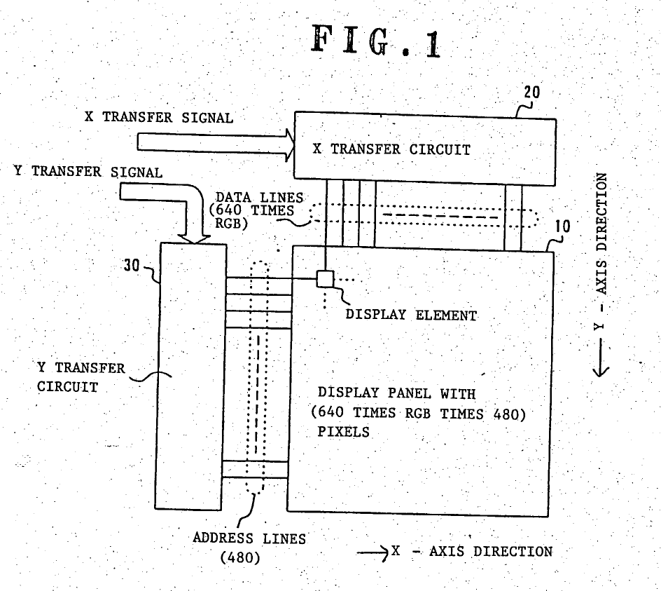

Now, described below is an X transfer circuit 201 for the display panel drive circuitry shown in FIG. 18. In the embodiment shown in FIG. 18, the Y transfer drive circuitry may employ the Y transfer circuit 300 (FIG. 4) according to the above-described embodiment, or alternatively the conventional Y transfer circuit 30 (FIG. 1). The display panel 10 is the same as that of the foregoing embodiments and will not be described repeatedly.

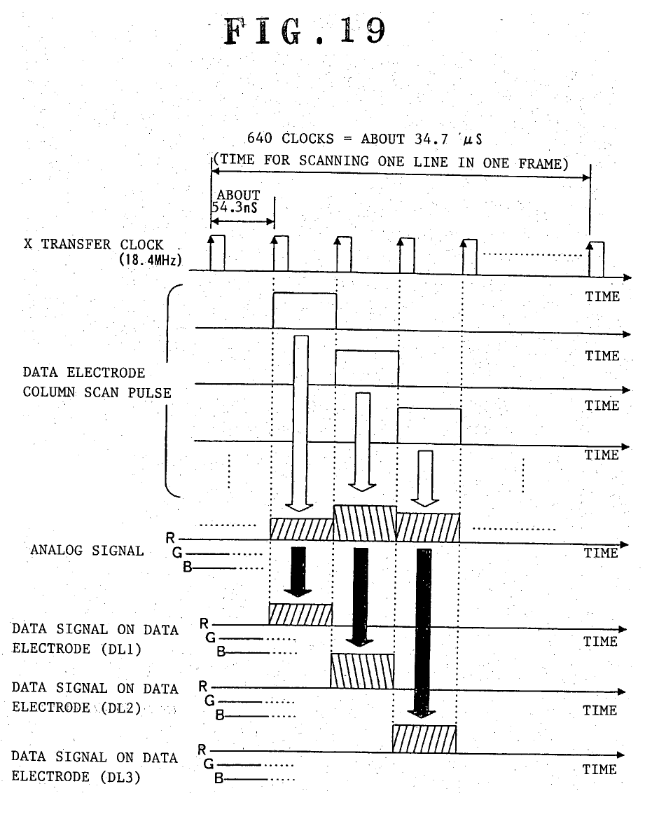

The X transfer circuit 201 is a data signal supply circuit that supplies R, G, and B analog signals as data signals to their respective columns of data electrodes of the display panel 10 in sync with an X transfer clock (about 18.4 MHz) supplied by a display panel controller (not shown). The generation of such data signals is described below in accordance with the time chart shown in FIG. 19.

As shown in FIG. 19, the X transfer circuit 201 that serves as a data signal supply circuit (for simplicity of description, the X transfer circuit 201 is hereinafter referred to as the data signal supply circuit) scans sequentially each of R, G, and B display elements of the display panel 10 in the group of display elements arrayed in 640 columns (DL1 to DL640) during 34.7 μs, thereby generating pulses to supply data signals to their data electrodes. The above-mentioned time 34.7 μs represents the time period required to scan each of the 480 rows of a display screen in one frame (1/60 Hz), that is, (1/60 Hz)/480 rows=34.7 μs.

As shown in FIG. 19, the data signal supply circuit first generates data electrode column scan pulses in sync with X transfer clocks. Using the data electrode column scan pulses, the data signal supply circuit samples each of R, G, and B analog signals to generate data signals, which will be supplied to each of the data electrodes DL1 to DL640 of each of R, G, and B display elements. Although FIG. 19 represents the sampling of an analog signal R, such sampling operation is also performed on each of other analog signals (i.e., G and B analog signals).

The internal configuration of the data signal supply circuit is described more specifically below. As shown in FIG. 18, the circuit comprises the group of data control lines for generating X address signals (hereinafter referred to as a “group of X control lines”) 22 on which address codes for generating data signals are superimposed, the X address signal generation data supply circuit (hereinafter referred to as the “X supply circuit”) 21 for supplying address codes to the group of X control lines 22 to generate data signals, X combinational logic circuits (hereinafter simply referred to as the “X combinational logic circuits”) 26 including a switch for sampling analog signals, and the group of analog signal input lines 24.

The address code is designed to decode the addresses of a column of data electrodes on the display panel 10. That is, the X supply circuit 21 counts the X transfer clocks, for example, with a predetermined scale-of-N binary counter, and then generates each of 2⁰ to 2^{N} digit pulse signals and pulse signals obtained by inverting each of these digits. The X supply circuit 21 uses a 2n-bit code having these pulse signals placed in parallel as the address code.

In the fourth embodiment shown in FIG. 18, the display panel 10 has 640 columns (DL1 to DL640) of data electrodes arrayed in the X-axis direction for each of R, G, and B display elements. Therefore, the number of bits for binary codes which is required to generate the addresses of each of the data electrodes DL1 to DL640 can be determined by the following relation:

1024>640>512,

or

2¹⁰>640>2⁹.

That is, it is found that 10-bit binary codes are sufficient.

Therefore, the X supply circuit 21 comprises a scale-of-640 binary counter for counting the X transfer clock and an inverter circuit (both not shown). That is, in FIG. 18, the address codes generated by the X supply circuit 21 include 10 (=n)-bit binary codes and their inverted codes. Thus, an address code of 20 (=2n) bits is supplied to the group of X control lines 22. That is, the group of X control lines 22 is made up of 20 X control lines with a binary code of 10 bits X9 (MSB) to X0 (LSB) and a binary code of their inverted bits X9b(MSB) to X0b(LSB) being superimposed thereon.

As described above, in order to count the X transfer clocks (at about 18.4 MHz), the 640-scale binary counter has a count step of about 54.3 ns (1/18.4 MHz). 54.3 ns is one period of the X transfer clock. The time required for the 640-scale binary counter to reach 640 counts is about 34.7 μs (about 54.3 ns times 640 steps) corresponding to a time period for scanning one row in a frame of display screen.

The X combinational logic circuits 26 include a combinational logic circuit formed of logic gate circuits such as AND gates or OR gates, and need to be provided for each column of data electrodes of each of R, G, and B display elements of the display panel 10. Thus, the fourth embodiment shown in FIG. 18 requires 640 (multiplied by R, G, and B) X combinational logic circuits 26 corresponding to each column of data electrodes DL1 to DL640 of each of R, G, and B display elements. Each of the X combinational logic circuits 26 is connected with 10 X control lines of 10 (=n) bits extracted from the group of X control lines 22.

That is, each of the X combinational logic circuits 26 uses those 10-bit codes to generate data electrode column scan pulses to select each of the data electrodes 12. As shown in the time chart of FIG. 19, the X combinational logic circuit 26 uses the data electrode column scan pulses to sample each analog signal for each of the R, G, and B display elements as a data signal, which is in turn supplied to each of the data electrodes 12 on the display panel 10.

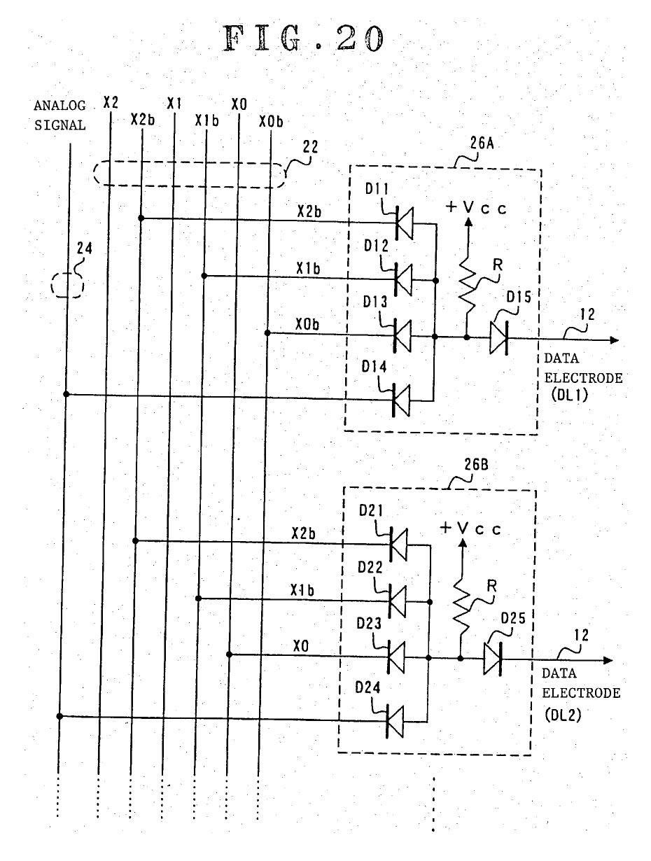

The specific operation and configuration of the X combinational logic circuit 26 will be described in more detail with reference to the circuit diagram illustrated in FIG. 20.

In FIG. 20, to simplify the descriptions on the operation and configuration of the X combinational logic circuit, the group of X control lines 22 is limited to a 3(=n)-bit binary code. In this case, the number of columns of data electrodes that can be decoded with such address codes is 2ⁿ=2³=8. That is, the binary code covers 8 columns of data electrodes from the first column of data electrodes (DL1) represented by a 3-bit binary code “000” to the eighth column of data electrodes (DL8) represented by a 3-bit binary code “111.” Although FIG. 20 illustrates only two X combinational logic circuits 26A and 26B for simplicity, there are also provided other like combinational logic circuits for their respective column of data electrodes DL1 to DL8.

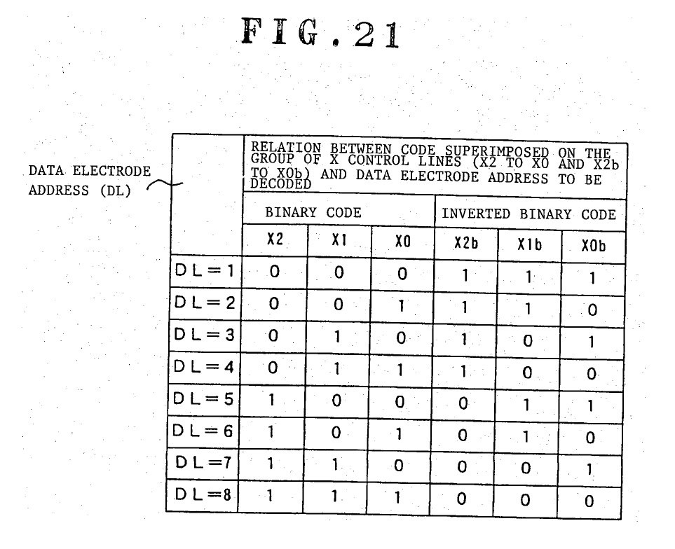

The group of X control lines 22 shown in FIG. 20 has a 6(=2n)-bit address code, superimposed thereon, of the binary code of X2(MSB) to X0(LSB) and the binary code of their inverted bits X2b(MSB) to X0b(LSB). Therefore, as shown in FIG. 21, upon decoding the columns of data electrodes DL1 to DL8, 3 bits of the 6-bit address code superimposed on the group of X control lines 22 take always on a logic level of “1,” with the remaining 3 bits inevitably taking on a logic level of “0.”

As can be seen from FIG. 20, in each of the X combinational logic circuits 26A and 26B, the cathodes of three input diodes are connected to the group of X control lines 22 such that each cathode serves as a digital signal input to the associated line in the group of X control lines 22. Such a group of diodes constitutes an AND circuit that decodes the address codes of columns of data electrodes.

As an analog signal input, the cathode of one of the input diodes is connected to a predetermined line in the group of analog signal input lines 24. The group of analog signal input lines 24 serves for each of R, G, and B analog signals, and has voltages superimposed thereon which are indicative of the amplitude of each of the R, G, and B analog signals. For simplicity of description, FIG. 20 illustrates only one predetermined line in such a group of analog signal input lines 24. The cathodes of the output diodes in the X combinational logic circuits 26A and 26B are connected to their respective data electrodes 12 corresponding to each of the combinational logic circuits. Such input and output diodes constitute a switching circuit for sampling analog signals.

All the anodes of the aforementioned diodes are connected in parallel and their connections or the common anodes of all the diodes are connected to the voltage supply Vcc via a resistor R.

In FIG. 20, a symbol VH designates the threshold voltage of a logic level of “1” of the address code superimposed on the group of X control lines 22, a symbol VL represents the threshold voltage of a logic level of “0,” and a symbol Van represents the voltage of an analog signal superimposed on an analog signal input line. In this embodiment, the following relationship holds true:

VH>Van>VL.

It is assumed here that a drop in the forward voltage of each diode is negligible.

All the three diodes are turned off at the timing at which all the cathodes of the three digital input diodes of each of the X combinational logic circuits 26A and 26B connected to the group of X control lines 22 are turned to a logic level of “1.” The diode for analog inputs maintains its ON state due to the voltage Van at its cathode being lower than the voltage Vcc at the anode.

At the aforementioned timing, the common anode of each of the X combinational logic circuits 26A and 26B has a potential equal to the voltage Van of the associated analog signal input line. Via an analog output diode, such voltage Van is supplied to the data electrode 12 connected to the cathode of the analog output diode of each combinational logic circuit.

In the circuit shown in FIG. 20, the X combinational logic circuit 26A corresponds to a decode circuit for the first column of data electrode or data electrode DL1, while the X combinational logic circuit 26B corresponds to a decode circuit for the second column of data electrode or data electrode DL2. The cathodes of the diodes D11 to D13 constituting the X combinational logic circuit 26A are connected with three X control lines X2b, X1b, X0b extracted from the group of X control lines 22, respectively. Likewise, the cathodes of the diodes in the X combinational logic circuit 26B are connected with three X lines X2b, X1b, X0 extracted from the group of X control lines 22, respectively.

As can be seen clearly from the relation shown in FIG. 21 between the data electrode address and the address code, upon decoding the data electrode DL1, the three bits X2b, X1b, X0b have a logic level of “1,” while upon decoding the data electrode DL2, the three bits X2b, X1b, X0 have a logic level of “1.” Therefore, with an address code indicative of a predetermined address, the combinational logic circuit associated with the address code supplies the voltage Van of the associated analog signal input line as a data signal to the predetermined data electrode 12.

According to this embodiment, it is thus possible to implement a data signal supply circuit in the display panel drive circuitry without using shift register or sample and hold circuits but only with simple combinational logic circuits incorporating diodes and analog switches. Accordingly, as materials for forming the display panel drive circuitry, it is possible to employ semiconductor materials, which are inexpensive and can facilitate fabrication, such as amorphous silicon materials or organic semiconductor materials.

The embodiment of the present invention for the X transfer circuit in the display panel drive circuitry is not limited to the example shown in FIG. 20 (fourth embodiment).

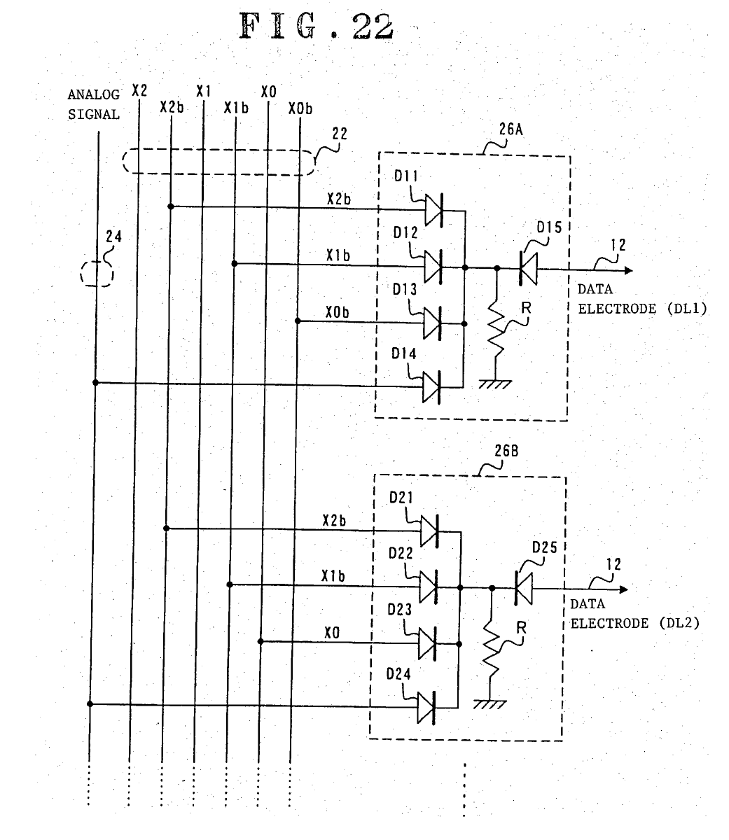

One modification to the fourth embodiment is illustrated in FIG. 22 (fifth embodiment). When the light-emitting element drive transistor Q2 included in the display element of the display panel 10 is of a P-channel type, it is necessary to drive the gate of Q2 with a negative voltage. In this case, as shown in FIG. 22, each combinational logic circuit may be formed of an OR circuit with the anodes of the diodes serving as inputs. In this case, as described above, the width of variation in logic level threshold voltage of an address code superimposed on the group of X control lines 22 may be so set as to be greater than the width of variation in voltage of an analog signal. This allows the value of the analog signal to appear at the common cathodes of the combinational logic circuit when all the anode inputs take on a logic level of “0.” The voltage of the analog signal is written in the storage capacitor in a manner such that the storage capacitor included in the display element of the display panel 10 is discharged.

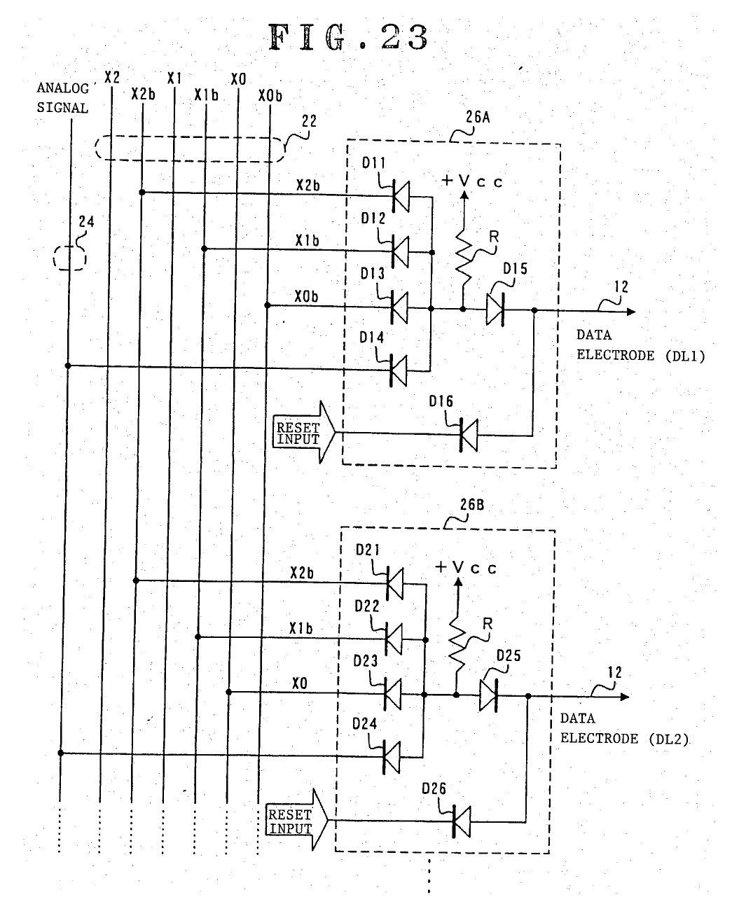

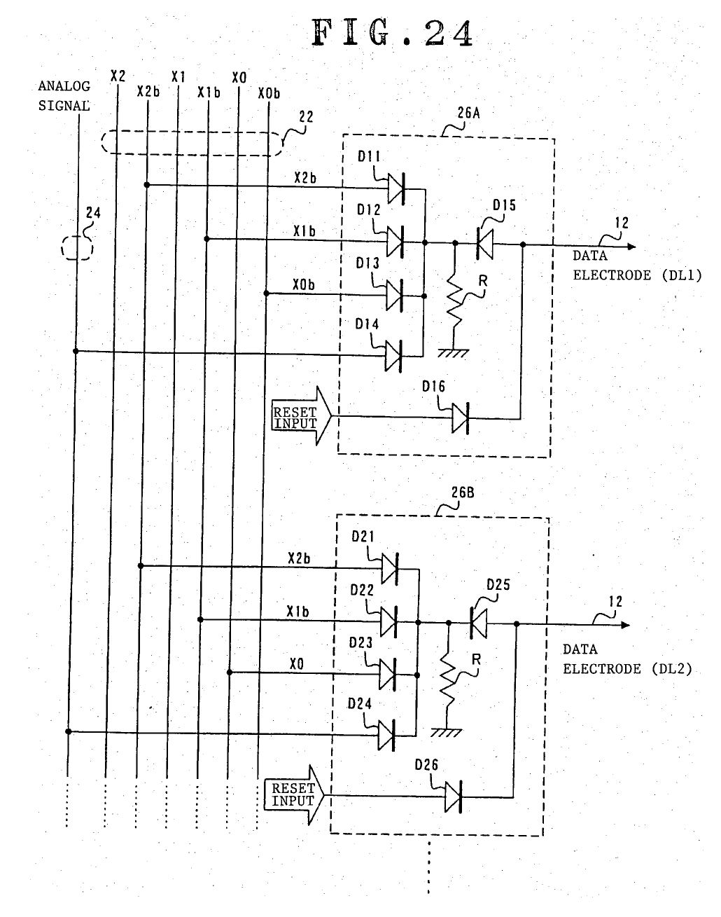

In each of the aforementioned circuits in FIGS. 20 and 22, data is written into the storage capacitor included in the display element of the display panel 10 via an output diode (D15 or D25), thereby causing a charge or discharge current into or from the storage capacitor to flow in one direction. In this context, an operation may be provided to reset the storage capacitor to ensure the writing of data at the predetermined timing before the data is written (FIGS. 23 and 24).

FIG. 23 illustrates an embodiment in which a reset switch circuit for performing such operation is added to the circuit shown in FIG. 20, and FIG. 24 illustrates an embodiment in which a reset switch circuit for performing such operation is added to the circuit shown in FIG. 22. In the case of an AND circuit shown in FIG. 23, the reset operation is intended to discharge the storage capacitor connected to the data electrode 12 to a predetermined low potential via a reset diode (D16, D26) before data is written. In the case of an OR circuit shown in FIG. 24, the reset operation is intended to charge the storage capacitor connected to the data electrode 12 to a predetermined high potential via a reset diode (D16, D26) before data is written.

As mentioned above in accordance with the Y transfer circuit, the group of diodes included in a combinational logic circuit described in accordance with the examples of FIGS. 20, 22, 23, and 24 may be replaced by other logic elements. For example, N-channel transistors may be used as logic elements in place of the diodes, in the case of which the logic circuits used for the aforementioned Y transfer circuit of FIGS. 7, 9, and 11 may also be used. Alternatively, to use P-channel transistors as logic elements, the logic circuits used for the aforementioned Y transfer circuit of FIGS. 8, 10, and 12 may also be used.

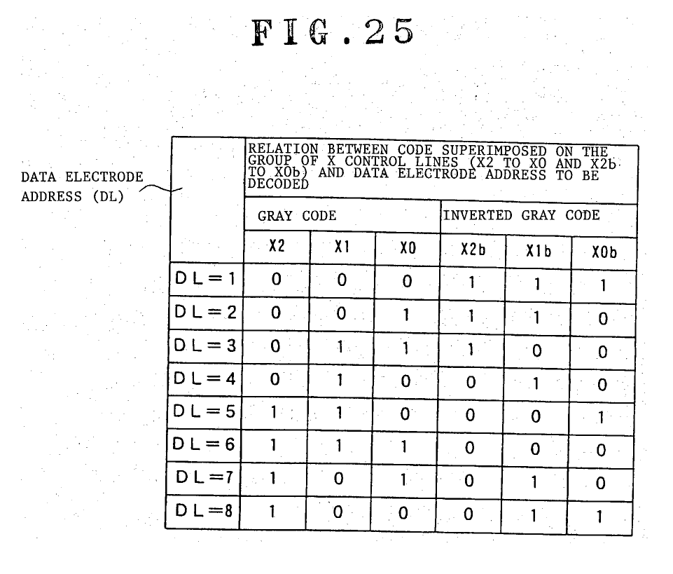

As shown in FIG. 25, as in the aforementioned Y transfer circuit, gray codes may also be used as address codes for decoding data electrode addresses. As can be seen from FIG. 25, in the case of gray codes, adjacent codes have only one different bit. The gray code can be used to reduce drawbacks such as a hazard occurring upon switching of input code data to the combinational logic circuit or unevenness of switching waveforms.

As described above, all the combinational logic circuits according to the embodiments can be formed only of single-polarity transistors, P-channel or N-channel, or diodes. Thus, according to the present invention, the display panel drive circuitry can be formed using an amorphous silicon material or organic semiconductor material without using a polysilicon material.

This application is based on two Japanese patent application Nos. 2003-3472, 2003-40649 and 2002-93856, and the entire disclosures thereof are incorporated herein by reference.

What is claimed is:

1. Drive circuitry for a display panel having a plurality of address electrodes and a plurality of data electrodes, intersecting one another with display elements being disposed therebetween, said drive circuitry comprising:
a plurality of address signal generation control lines;
an address signal generation data supply circuit for supplying coded address signal generation data to said plurality of address signal generation control lines such that each digit of said coded address signal generation data corresponds to each of said plurality of address signal generation control lines; and
a plurality of combinational logic circuits for capturing at least some of said address signal generation control lines to generate an address signal in accordance with states of bits on said captured control lines, wherein an output of each of said combinational logic circuits is connected to each of said address electrodes.

2. The display panel drive circuitry according to claim 1, wherein said address signal generation data is coded with a binary code varied in accordance with a predetermined clock and an inverted code of the binary code.

3. The display panel drive circuitry according to claim 1, wherein said address signal generation data is coded with a gray code varied in accordance with a predetermined clock and an inverted code of the gray code.

4. The display panel drive circuitry according to claim 1, wherein said combinational logic circuit is an AND circuit formed of N-channel transistors connected in series.

5. The display panel drive circuitry according to claim 1, wherein said combinational logic circuit is a NOR circuit formed of N-channel transistors connected in parallel.

6. The display panel drive circuitry according to claim 1, wherein said combinational logic circuit is a complex logic circuit comprising an AND circuit formed of N-channel transistors connected in series and a NOR circuit formed of N-channel transistors connected in parallel.

7. The display panel drive circuitry according to claim 1, wherein said combinational logic circuit is an OR circuit formed of P-channel transistors connected in series.

8. The display panel drive circuitry according to claim 1, wherein said combinational logic circuit is a NAND circuit formed of P-channel transistors connected in parallel.

9. The display panel drive circuitry according to claim 1, wherein said combinational logic circuit is a complex logic circuit comprising an OR circuit formed of P-channel transistors connected in series and a NAND circuit formed of P-channel transistors connected in parallel.

10. The display panel drive circuitry according to claim 1, wherein said combinational logic circuit is an AND circuit formed of diodes connected in parallel or an OR circuit.

11. The display panel drive circuitry according to claim 1, wherein said display element is an organic electroluminescent light-emitting element.

12. The display panel drive circuitry according to claim 1, wherein said display element is a liquid crystal display element.

13. The display panel drive circuitry according to claim 1 further comprising:
a plurality of sample and hold circuits for holding supplied data and supplying the held data as display data to each of said data electrodes in response to a data transfer pulse;
a plurality of data transfer pulse generation control lines;
a data transfer pulse generation data supply circuit for supplying coded data transfer pulse generation data to said data transfer pulse generation control lines with each digit of said generation data corresponding to each control line; and
a plurality of data transfer pulse generation combinational logic circuits for capturing some of said data transfer pulse generation control lines to generate said data transfer pulse in accordance with states of bits on said captured control lines and then supplying said data transfer pulse to each of said sample and hold circuits.

14. The display panel drive circuitry according to claim 13, wherein said sample and hold circuit includes a sampling switch circuit for supplying said supplied data to each of said data electrodes in response to said data transfer pulse.

15. The display panel drive circuitry according to claim 13, wherein said data transfer pulse generation data is coded with a binary code varied in accordance with a predetermined clock and an inverted code of the binary code.

16. The display panel drive circuitry according to claim 13, wherein said data transfer pulse generation data is coded with a gray code varied in accordance with a predetermined clock and an inverted code of the gray code.

17. The display panel drive circuitry according to claim 13, wherein said data transfer pulse generation combinational logic circuit is an AND circuit or an OR circuit formed of diodes connected in parallel.

18. The display panel drive circuitry according to claim 13, wherein said data transfer pulse generation combinational logic circuit is an AND circuit formed of N-channel transistors connected in series.

19. The display panel drive circuitry according to claim 13, wherein said data transfer pulse generation combinational logic circuit is a NOR circuit formed of N-channel transistors connected in parallel.

20. The display panel drive circuitry according to claim 13, wherein said data transfer pulse generation combinational logic circuit is a complex logic circuit comprising an AND circuit formed of N-channel transistors connected in series and a NOR circuit formed of N-channel transistors connected in parallel.

21. The display panel drive circuitry according to claim 13, wherein said data transfer pulse generation combinational logic circuit is an OR circuit formed of P-channel transistors connected in series.

22. The display panel drive circuitry according to claim 13, wherein said data transfer pulse generation combinational logic circuit is a NAND circuit formed of P-channel transistors connected in parallel.

23. The display panel drive circuitry according to claim 13, wherein said data transfer pulse generation combinational logic circuit is a complex logic circuit comprising an OR circuit formed of P-channel transistors connected in series and a NAND circuit formed of P-channel transistors connected in parallel.

24. The display panel drive circuitry according to claim 13 further comprising a switching circuit with one end connected to each of said data electrodes and the other end connected to a predetermined reset voltage supply.
